(19) United States
(12) Patent Application Publication
(10) Pub. No.: US 2023/0077036 A1
(43) Pub. Date: Mar. 9, 2023

(54) VEHICLE TRAVEL CONTROL DEVICE

(71) Applicant: Mitsubishi Electric Corporation, Tokyo (JP)

(72) Inventors: Shinji YAMAGUCHI, Hyogo (JP); Kazuhiro NISHIWAKI, Tokyo (JP)

(73) Assignee: Mitsubishi Electric Corporation, Tokyo (JP)

(21) Appl. No.: 17/799,744

(22) PCT Filed: Apr. 17, 2020
(86) PCT No.: PCT/JP2020/016847

§ 371 Date: Aug. 15, 2022

(51) Int. Cl. B60W 30/16; B60W 30/18; B60W 40/105

(52) U.S. Cl. CPC B60W 30/16; B60W 30/18163; B60W 40/105; B60W 2554/80

(57) ABSTRACT

A vehicle travel control device is equipped with a target vehicle speed setting part which outputs a set up target vehicle speed, a constant speed travel controller which outputs a first acceleration instruction for constant speed travel from the speed of a host vehicle and the target vehicle speed, a target inter vehicle distance setting part which outputs a target inter vehicle distance between a preceding vehicle and the host vehicle, an inter vehicle distance controller which outputs a second acceleration instruction for controlling to the target inter vehicle distance, and a control selection part which selects either the first acceleration instruction or the second acceleration instruction, to make an acceleration instruction. The control selection part has a predetermined switching acceleration, and is configured to select the second acceleration instruction of the inter vehicle distance controller, when it is judged that the second acceleration instruction exceeds the switching acceleration.

### FIELD OF THE INVENTION

The present application relates to the field of a vehicle travel control device.

### BACKGROUND OF THE INVENTION

A vehicle travel control device is a system which automatically switches between constant speed travel control and inter vehicle distance control, according to the traffic situations during driving, to reduce the load of a driven where in the constant speed travel control, a host vehicle travels at a vehicle speed which the driver sets up, and in the inter vehicle distance control, the host vehicle maintains an inter vehicle distance from a preceding vehicle which is located at the front side of the host vehicle.

As a vehicle travel control device, there is a technique to switch the control to the deceleration or maintenance of a vehicle speed, when the inter vehicle distance falls below a safe inter vehicle distance, where, in contrast with a target inter vehicle distance between a host vehicle and a preceding vehicle, defined as “present vehicle speed×2.5 seconds”, the safe inter vehicle distance is defined as “target inter vehicle distance−relative speed×4 seconds”. By contrast with this technique, in Patent Document 1, an allowable minimum inter vehicle distance, which is shorter than the safe inter vehicle distance, is defined based on the vehicle speed of a host vehicle, and a relative speed with respect to a preceding vehicle. According to the relationship between the inter vehicle distance and the allowable minimum inter vehicle distance, a control device switches among the deceleration by a brake, the deceleration by a throttle, and the maintenance of vehicle speed. Thereby, also even when another vehicle interrupts while the host vehicle following a preceding vehicle, the control device enables the driving to follow up without deteriorating drivability.

### CITATION LIST

### Patent Literature

Patent Document 1: Japanese Unexamined Patent Application Publication No. Hei 5-104993

### SUMMARY OF THE INVENTION

### Technical Problem

According to the technique of the Patent Document 1, in the situation where a host vehicle approaches a distant and slow preceding vehicle, when the inter vehicle distance falls below the “target inter vehicle distance−relative speed×4 seconds”, or the safe distance, the constant speed travel control is switched to the inter vehicle distance control.

However, in the situation where the speed difference with a preceding vehicle is large, the timing to switch to the inter vehicle distance control is late, and then, a large deceleration will be caused, and in addition, there is a concern that a driver may feel uncomfortable. The present application discloses a technique for solving the above problems. And an object of the present invention is to provide a vehicle travel control device which switches between the constant speed travel control and the inter vehicle distance control, and decelerates a host vehicle, without giving a sense of discomfort to a driver.

### Solution to Problem

A vehicle travel control device, which is disclosed in the present application includes:

a target vehicle speed setting part which outputs a set up target vehicle speed,

a constant speed travel controller which outputs a first acceleration instruction for constant speed travel, from a speed of a host vehicle and the target vehicle speed,

a target inter vehicle distance setting part which outputs a target inter vehicle distance between a preceding vehicle and the host vehicle,

an inter vehicle distance controller which outputs a second acceleration instruction for controlling to the target inter vehicle distance, based on a relative speed and an inter vehicle distance between the preceding vehicle and the host vehicle, and

a control selection part which receives the first acceleration instruction from the constant speed travel controller and the second acceleration instruction from the inter vehicle distance controller, and selects one of the instructions to make an acceleration instruction,

wherein, the control selection part has a predetermined switching acceleration, and selects the second acceleration instruction of the inter vehicle distance controller, when it is judged that the second acceleration instruction may exceed the switching acceleration.

### Advantageous Effects of Invention

According to the vehicle travel control device disclosed in the present application, when switching between the constant speed travel control and the inter vehicle distance control is carried out to perform acceleration or deceleration, the vehicle travel control device can start acceleration or deceleration, without giving a sense of discomfort to a driver.

### BRIEF EXPLANATION OF DRAWINGS

FIG. 1 is a block diagram which shows the constitution of the vehicle travel control device of the Embodiment 1.

FIG. 2 is a first explanatory diagram which shows the operation of the control selection part of the Embodiment 1.

FIG. 3 is a block diagram which shows the hardware constitution of the vehicle travel control device of the Embodiment 1.

FIG. 4 is a block diagram which shows the hardware constitution of the vehicle travel control device of the Embodiment 1.

FIG. 5 is a second explanatory diagram which shows the operation of the control selection part of the Embodiment 1.

FIG. 6 is a third explanatory diagram which shows the operation of the control selection part of the Embodiment 1.

FIG. 7 is a fourth explanatory diagram which shows the operation of the control selection part of the Embodiment 1.

FIG. 8 is a fifth explanatory diagram which shows the operation of the control selection part of the Embodiment 1.

FIG. 9 is a block diagram which shows the constitution of the modified example of the vehicle travel control device of the Embodiment 1.

FIG. 10 is a block diagram which shows the constitution of the vehicle travel control device of the Embodiment 2.

FIG. 11 is a first explanatory diagram which shows the operation of the control selection part of the Embodiment 2.

FIG. 12 is a second explanatory diagram which shows the operation of the control selection part of the Embodiment 2.

FIG. 13 is a block diagram which shows the constitution of the vehicle travel control device of the Embodiment 3.

FIG. 14 is an explanatory diagram which shows the operation example of the moving average filter of the Embodiment 3.

FIG. 15 is an explanatory diagram which shows the operation of the control selection part of the Embodiment 3.

### DESCRIPTION OF EMBODIMENTS

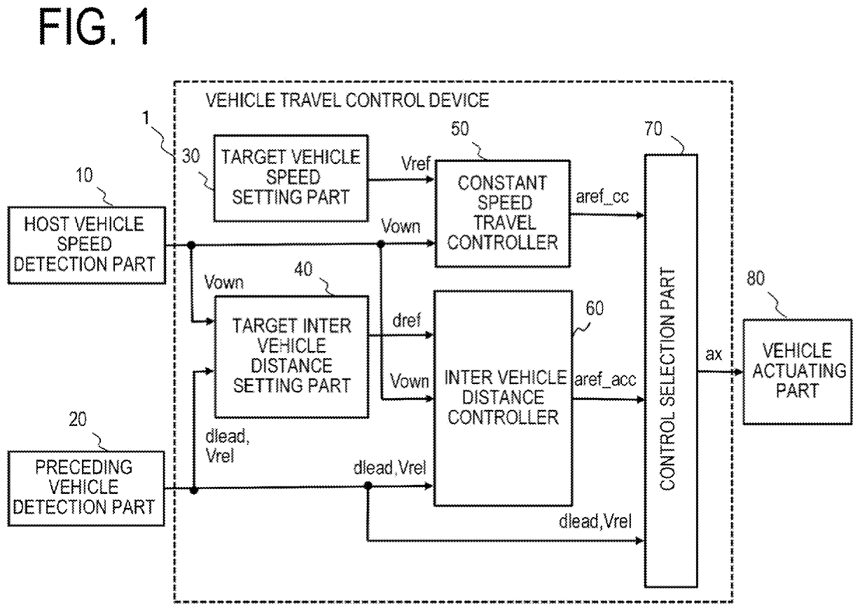

Hereinafter, explanation will be made about the vehicle travel control device in accordance with Embodiments of the present application, referring from FIG. 1 to FIG. 15. It is worth noticing that, among drawings, each of the same numerals shows the same or corresponding portion.

### Embodiment 1

Based on FIG. 1, the vehicle travel control device 1 according to the Embodiment 1 will be explained. FIG. 1 is a schematic block diagram showing the constitution of the vehicle travel control device 1. In the present Embodiment 1, explained is a vehicle travel control device 1, in which a host vehicle is conscious of vehicles in the vicinity and controls the acceleration and deceleration for the travel of the host vehicle. It is worth noticing that, explained here is a case in which a preceding vehicle is treated as an objective vehicle in the vicinity.

In response to the output signal of a host vehicle speed detection part 10, and the output signal of a preceding vehicle detection part 20, the vehicle travel control device 1 carries out the control of a vehicle actuating part 80. The host vehicle speed detection part 10 is a sensor which outputs a host vehicle speed v_{own}. The preceding vehicle detection part 20 detects an inter vehicle distance d_{lead}, with respect to a preceding vehicle which travels at the front side of a host vehicle, and a relative speed vᵣₑₗ of the preceding vehicle, with respect to the host vehicle. As the preceding vehicle detection part 20, sensors, for example, a milli wave radar, a camera, a sonar sensor (ultrasonic sensor), a LiDAR, and the like can be used.

As shown in FIG. 1, the vehicle travel control device 1 is equipped with a target vehicle speed setting part 30, a target inter vehicle distance setting part 40, a constant speed travel controller 50, an inter vehicle distance controller 60, and a control selection part 70.

In the target vehicle speed setting part 30, a target vehicle speed v_{ref} is set up by the operation of a driver, and the signal of the target vehicle speed v_{ref} can be acquired from the target vehicle speed setting part 30.

The host vehicle speed v_{own}, which is detected in the host vehicle speed detection part 10, is input into the target inter vehicle distance setting part 40, the constant speed travel controller 50, and the inter vehicle distance controller 60. Moreover, the inter vehicle distance d_{lead} and the relative speed vᵣₑₗ, with respect to the preceding vehicle, which are detected in the preceding vehicle detection part 20, are input into the target inter vehicle distance setting part 40, the inter vehicle distance controller 60, and the control selection part 70.

The target inter vehicle distance setting part 40 is a block which sets up a target inter vehicle distance in the inter vehicle distance controller 60. The target inter vehicle distance setting part 40 calculates a target inter vehicle distance d_{ref} to output, based on, like the Formula 1, the host vehicle speed v_{own} which is detected in the host vehicle speed detection part 10, and the relative speed vᵣₑₗ which is detected in the preceding vehicle detection part 20.

### Formula 1

Formula 1

d_{ref}=T_{hw}×(v_{own}+vᵣₑₗ)+Dₛₜₒₚ (1)

It is worth noticing that, in the Formula 1, symbol T_{hw} is a coefficient and symbol Dₛₜₒₚ is an offset, and the target inter vehicle distance d_{ref} is a distance in the case where a preceding vehicle is stopped. As the coefficient T_{hw} and the offset Dₛₜₒₚ, combination of multiple values is prepared in advance. Thus, a driver can select a target inter vehicle distance d_{ref}, from multiple stages, such as, a plurality of inter vehicle settings, for example, “long distance”, “middle distance”, and “short distance”.

The constant speed travel controller 50 calculates and outputs an acceleration instruction a_{ref_cc} (first acceleration instruction) for making the host vehicle speed v_{own} follow the target vehicle speed v_{ref}, based on the host vehicle speed v_{own} which is detected by the host vehicle speed detection part 10, and the target vehicle speed v_{ref} which is output from the target vehicle speed setting part 30.

Moreover, based on the host vehicle speed v_{own}, which is detected by the host vehicle speed detection part 10, the inter vehicle distance d_{lead} and the relative speed vᵣₑₗ, which are detected in the preceding vehicle detection part 20, and the target inter vehicle distance d_{ref}, which is output by the target inter vehicle distance setting part 40, the inter vehicle distance controller 60 calculates an acceleration instruction a_{ref_acc} (second acceleration instruction) for running, maintaining the inter vehicle distance d_{lead} with respect to a preceding vehicle. That is, when the vehicle speed of a preceding vehicle becomes slower, the inter vehicle distance controller controls to lower the host vehicle speed v_{own}, in order to maintain the target inter vehicle distance d_{ref}, which is set up in the target inter vehicle distance setting part 40.

Based on the inter vehicle distance d_{lead} and the relative speed vᵣₑₗ, which are output from the preceding vehicle detection part 20, the control selection part 70 selects whether to use the first acceleration instruction a_{ref_cc} of the constant speed travel controller 50, or to use the second acceleration instruction a_{ref_acc} of the inter vehicle distance controller 60, and outputs one of them, that is, an acceleration instruction ax. Namely, in the control selection part 70, input are the first acceleration instruction a_{ref_cc} from the constant speed travel controller 50; the second acceleration instruction a_{ref_acc} from the inter vehicle distance controller 60; the target inter vehicle distance d_{ref} from the target inter vehicle distance setting part 40; and the inter vehicle distance d_{lead} and relative speed vᵣₑₗ from the preceding vehicle detection part 20. Based on these inputs, the acceleration instruction ax, selected from two acceleration instructions, is output to the vehicle actuating part 80. According to the acceleration instruction ax, the vehicle actuating part 80 controls an engine or a drive motor, or a brake. Further, the vehicle actuating part gives a braking force or a driving force, so that the acceleration of a host vehicle may match with the acceleration instruction ax.

Explanation will be made about how to select, in the control selection part 70, the first acceleration instruction a_{ref_cc} or the second acceleration instruction a_{ref_acc}.

In the situation where the inter vehicle distance d_{lead} is larger than the target inter vehicle distance d_{ref}, and the host vehicle speed v_{own} is larger than the preceding vehicle speed v_{lead}, namely, in the situation where the relative speed vᵣₑₗ is negative, the host vehicle decelerates, from the host vehicle speed v_{own} to the preceding vehicle speed v_{lead}, and at the same time, the host vehicle approaches from the inter vehicle distance d_{lead} to the target inter vehicle distance d_{ref}, at a fixed deceleration A_{deccel} (A_{deccel}>0). In this situation, the relation of the following Formula 2 is satisfied.

$$[ Formula 2 ]$$

$$\begin{matrix}Formula 2 & \\ {d}_{lead} = \frac{{v}_{rel}^{2}}{( 2 \times {A}_{d e ccel} )} + {d}_{ref} & ( 2 )\end{matrix}$$

It is worth noticing that, the Formula 2 means that, when the inter vehicle distance d_{lead} falls below a distance on the right hand side of the Formula 2, a deceleration larger than the deceleration A_{deccel} is required, in order to converge to the target inter vehicle distance d_{ref}.

Almost in the same way, in the situation where the inter vehicle distance d_{lead} is smaller than the target inter vehicle distance d_{ref}, and the host vehicle speed v_{own} is smaller than the preceding vehicle speed v_{lead}, namely, in the situation where the relative speed vᵣₑₗ is positive, the host vehicle accelerates from the host vehicle speed v_{own} to the preceding vehicle speed v lead, and at the same time, the host vehicle separates from the inter vehicle distance d_{lead} to the target inter vehicle distance d_{ref}, at a fixed acceleration A_{accel} (A_{accel}>0). In this situation, the relation of the following Formula 3 is satisfied.

$$[ Formula 3 ]$$

$$\begin{matrix}Formula 3 & \\ {d}_{lead} = \frac{{v}_{rel}^{2}}{( 2 \times {A}_{deccel} )} + {d}_{ref} & ( 3 )\end{matrix}$$

The Formula 3 means that, when the inter vehicle distance d_{lead} falls below a distance on the right hand side of the Formula 3, an acceleration smaller than the acceleration A_{accel} is required, in order to converge to the target inter vehicle distance d_{ref}.

From the Formula 2 and the Formula 3, the conditions for selecting an output in the control selection part 70 is given in the Formula 4.

$$[ Formula 4 ]$$

$$\begin{matrix}Formula 4 & \\ {d}_{lead} < \frac{- sign ( {v}_{rel} ) \times {v}_{rel}^{2}}{( 2 \times {A}_{a c c} )} + {d}_{ref} & ( 4 )\end{matrix}$$

It is worth noticing that, in the Formula 4, symbol A_{acc} is switching acceleration and a predetermined parameter. Moreover, symbol sign (x) is signum function, and in the case of x>0, the output is sign (x)=+1. In the case of x<0, the output is sign (x)=−1, and in the case of x=0, the output is sign (x)=0. When the Formula 4 is satisfied, the control selection part 70 selects a second acceleration instruction a_{ref_acc}, which the inter vehicle distance controller 60 outputs.

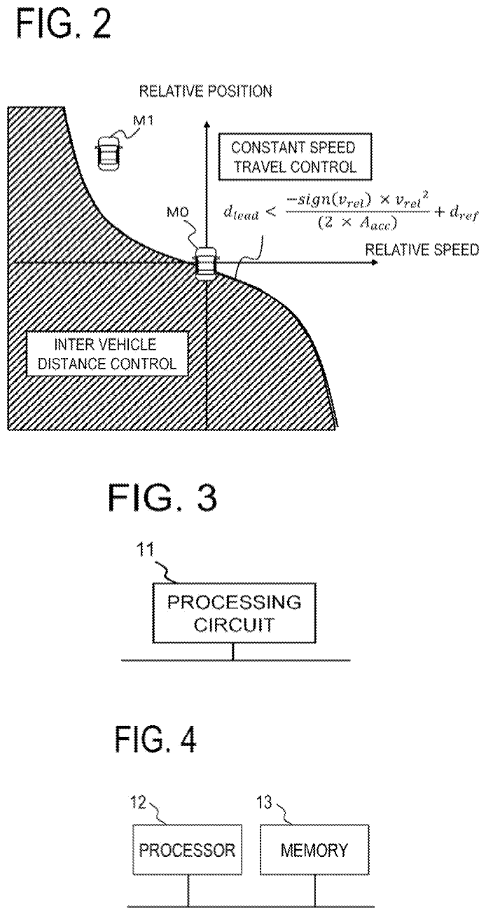

In FIG. 2, a domain is hatched, which shows the area where the control selection part 70 selects the inter vehicle distance control which is defined by the Formula 4. The boundary of the hatched domain is based on the Formula 4. In FIG. 2, the horizontal axis indicates the relative speed vᵣₑₗ between the preceding vehicle M1 and the host vehicle M0, and the vertical axis indicates the relative position between the preceding vehicle M1 and the host vehicle M0, i.e., the inter vehicle distance d_{lead} Further, a right hand side part, i.e., the first quadrant and the fourth quadrant show a domain in which a host vehicle M0 is slower than a preceding vehicle M1, and a left hand side part, i.e., the second quadrant and the third quadrant show a domain in which the host vehicle M0 is faster than the preceding vehicle. Further, an upper side part, i.e., the first quadrant and the second quadrant show a domain in which the preceding vehicle M1 is at a distant place. Therefore, the first quadrant shows a case where the preceding vehicle M1 is faster than the host vehicle M0 and located at a distant place, and the second quadrant shows a case where the preceding vehicle M1 is slower and located at a distant place, and the third quadrant shows a case where the preceding vehicle M1 is slower and located close to the host vehicle, and the fourth quadrant shows a case where the preceding vehicle M1 is faster and is located close to the host vehicle.

The vehicle travel control device 1 which is explained above can be constituted using a computer, and each of these constitutions is achieved when computer runs a program. That is, the target vehicle speed setting part 30, the target inter vehicle distance setting part 40, the constant speed travel controller 50, the inter vehicle distance controller 60, and the control selection part 70, which constitute the vehicle travel control device 1 shown in FIG. 1, are achieved, for example, by the processing circuit 11 shown in FIG. 3. In the processing circuit 11, processors, such as CPU (Central Processing Unit), DSP (Digital Signal Processor), are applied, and the function of each of the above constitutions can be achieved by running programs stored in a memory storage.

It is worth noticing that, hardware of exclusive use may be applied as the processing circuit 11. When the processing circuit 11 is hardware of exclusive use, the processing circuit 11 can be achieved, for example, by a single circuit, a compound circuit, a programmed processor, a parallel programed processor, ASIC (Application Specific Integrated Circuit), FPGA (Field Programmable Gate Array), or the combination of these items.

Moreover, each composition (the target vehicle speed setting part 30, the target inter vehicle distance setting part 40, the constant speed travel controller 50, the inter vehicle distance controller 60, and the control selection part 70) of the vehicle travel control device 1 is shown in FIG. 1. The constitution of hardware is shown in FIG. 4, in the case where those compositions are configured using the processor 12. In this case, each constitution function of the vehicle travel control device 1 is achieved by the combination, such as software and the like (software, firmware, or software and firmware). Software and others are described as programs and stored in the memory 13 (memory storage). The processor 12 which functions as the processing circuit 11 achieves the function of each constitution, by reading out and running the programs memorized in the memory 13.

### <Operation>

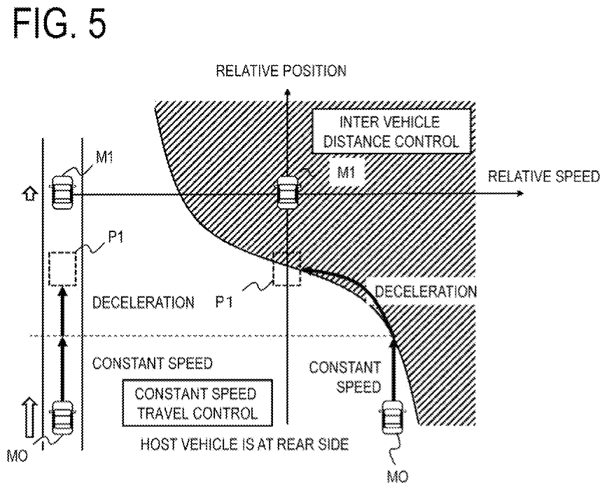

Next, explanation will be made about the operation of the vehicle travel control device 1. FIG. 5 is an explanatory diagram for explaining the operation of the control selection part 70.

In FIG. 5, a case is shown where, while a preceding vehicle M1 which is at the front side and at a distant place is running on the same lane as the host vehicle M0, the host vehicle M0 is approaching the preceding vehicle M1, from the rear side, at a speed faster than the preceding vehicle. At this time, using the constant speed travel control, the host vehicle M0 is carrying out a constant speed travel, at a target vehicle speed which is set up in the target vehicle speed setting part 30.

The drawing on the left hand side of FIG. 5 shows the positional relationship between the preceding vehicle M1 and the host vehicle M0. And, the drawing on the right hand side of FIG. 5 shows a graph, where the horizontal axis indicates the relative speed vᵣₑₗ between the preceding vehicle M1 and the host vehicle M0, and the vertical axis indicates the relative position of the host vehicle M0, with respect to the preceding vehicle M1. And, the hatched domain of the right drawing in FIG. 5 is an area, in which the conditions of the Formula 4 are fulfilled and switching is carried out to the inter vehicle distance control. In order to describe the operation example of the present Embodiment, in association with a drawing on the left hand side and a drawing on the right hand side, the right side graph of FIG. 5 is shown based on the graph of FIG. 2, where the horizontal axis indicates the relative speed vᵣₑₗ and the vertical axis indicates the inter vehicle distance, by inverting both the vertical axis and the horizontal axis. In the following description of other operation examples, the horizontal axis represents the relative speed vᵣₑₗ of the host vehicle with respect to the preceding vehicle speed, and the vertical axis represents the relative position of the host vehicle M0 with respect to the preceding vehicle M1.

When the host vehicle M0 approaches, with constant speed travel, the preceding vehicle M1 to some extent, the constant speed travel control is switched to the inter vehicle distance control, at the timing of entering the hatched domain. Further, the host vehicle M0 is controlled by the inter vehicle distance control, and the host vehicle M0 is smoothly decelerated and moved to the target position P1, shown in FIG. 5.

As shown in FIG. 5, the timing of switching from the constant speed travel control to the inter vehicle distance control is defined by the curve of the Formula 4. In this situation, the Formula 4 indicates a curve which converges to the target inter vehicle distance d_{ref}, at a fixed deceleration A_{acc}. Thus, when converging to the target inter vehicle distance d_{ref} by the inter vehicle distance control, the deceleration always becomes larger than the switching acceleration A_{acc}. Therefore, the magnitude of the deceleration which occurs in this situation can be adjusted by the switching acceleration A_{acc}. That is, when it is judged that the second acceleration instruction exceeds the switching acceleration, the control selection part selects the second acceleration instruction of the inter vehicle distance controller.

The above Formula 4 is defined by a secondary expression, with respect to the relative speed vᵣₑₗ. Therefore, also in the situation where the relative speed vᵣₑₗ is large, it is possible to switch to the inter vehicle distance control at an early timing, and the occurrence of a large deceleration which may deteriorate drivability can be restrained.

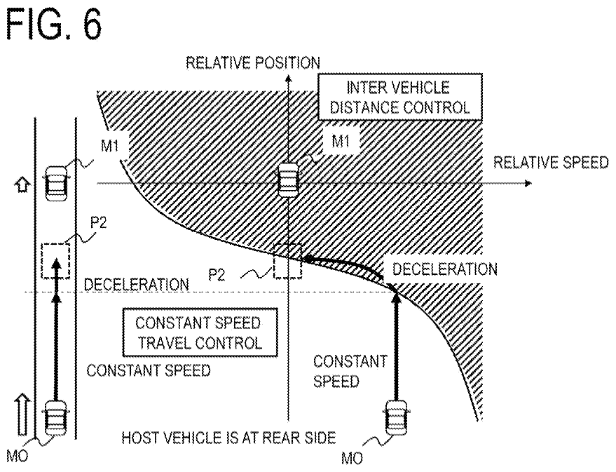

FIG. 6 is an explanatory diagram for explaining the operation of the control selection part 70, which is in another running situation according to the Embodiment 1.

As shown in FIG. 6, for example, when driving in an urban area or the like, the preceding vehicle M1 is running at a low speed or stopped, at the front side of the same lane as the host vehicle M0. In that situation, when the host vehicle is approaching from the rear side of the preceding vehicle M1, whose speed is slower than the host vehicle M0, deceleration starts at the same timing as when driving on a high-speed way, and then, it is probable that the host vehicle maybe delayed to reach the target position P2.

In the Embodiment 1, the feature is in that, as the preceding vehicle speed is smaller, the switching acceleration A_{ace} is made larger, where the switching acceleration is a parameter on the conditions for switching to the inter vehicle distance control, which is defined by the Formula 4. According to this, when the host vehicle approaches from the rear side of the preceding vehicle M1 whose speed is slower than the host vehicle M0, the host vehicle does not start deceleration at an early stage. Thereby, it becomes possible, without deterioration of drivability, to switch from the constant speed travel control to the inter vehicle distance control, and to move the host vehicle M0 to the target position P2 smoothly.

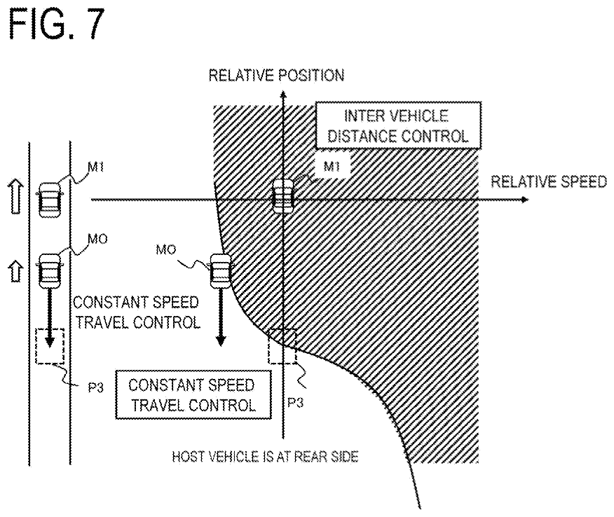

FIG. 7 is an explanatory diagram for explaining the operation of the control selection part 70, which is in another running situation according to the Embodiment 1.

As shown in FIG. 7, the speed of the host vehicle M0 is fast, and the preceding vehicle M1 is interrupting at the front side of the same lane as the host vehicle M0. In this situation, when the constant speed travel control is switched to the inter vehicle distance control, it is probable that the host vehicle may decelerate more than needed.

When the preceding vehicle speed is larger than the host vehicle speed v_{own}, namely, when the relative speed vᵣₑₗ of the preceding vehicle M1 with respect to the host vehicle M0 is positive, the feature is in that, the switching acceleration A ace is made smaller, compared with the case where the relative speed vᵣₑₗ is negative. Thereby, in the running situation where the fast preceding vehicle M1 interrupts at the front side of the host vehicle M0, it becomes possible to continue the constant speed travel control, without switching to the inter vehicle distance control. Therefore, the unnecessary deceleration by switching to the inter vehicle distance control can be restrained, and the host vehicle M0 can be smoothly moved to the target position P3.

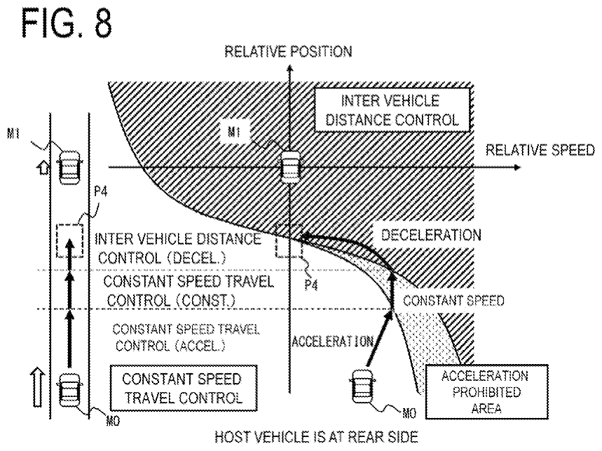

FIG. 8 is an explanatory diagram for explaining the operation of the control selection part 70, which is in another running situation according to the Embodiment 1.

As shown in FIG. 8, a host vehicle M0 is running at a speed lower than the target vehicle speed which is set up in the target vehicle speed setting part 30. In this situation, when the host vehicle approaches a preceding vehicle M1 at the front side and at a distant place, from the rear side, where the preceding vehicle is on the same lane as the host vehicle M0, and has a vehicle speed lower than the host vehicle M0, there is a case where, before switching to the inter vehicle distance control and decelerating, the host vehicle may be accelerated excessively by the constant speed travel control.

In such a case, by the following Formula 5, the constant speed travel controller 50 prohibits acceleration. In the Formula, used are the inter vehicle distance d_{lead} and relative speed v which are with respect to the preceding vehicle M1 and detected in the preceding vehicle detection part 20, the target inter vehicle distance d_{ref} which is set up in the target inter vehicle distance setting part 40, and an acceleration prohibited acceleration A_{cc} which is set up beforehand.

$$[ Formula 5 ]$$

$$\begin{matrix}Formula 5 & \\ {d}_{lead} < \frac{- sign ( {v}_{rel} ) \times {v}_{rel}^{2}}{( 2 \times {A}_{a c c} )} + {d}_{ref} & ( 5 )\end{matrix}$$

When the Formula 5 is satisfied, the constant speed travel controller 50 prohibits acceleration, in the domain between the curve of the Formula 4 and the curve of the Formula 5. That is, even when the host vehicle speed is less than the target vehicle speed, the constant speed travel controller 50 maintains a present vehicle speed. And, when the above Formula 4 is satisfied, the control selection part 70 selects a second acceleration instruction a_{ref_acc} which the inter vehicle distance controller 60 outputs.

Thereby, just before switching to the deceleration by the inter vehicle distance control, it becomes possible to restrain the unnecessary acceleration by the constant speed travel control. And, without giving a sense of discomfort to a driver, the vehicle travel control device can switch from the constant speed travel control to the inter vehicle distance control, and can move the host vehicle M0 to the target position P4 smoothly.

### Modified Example

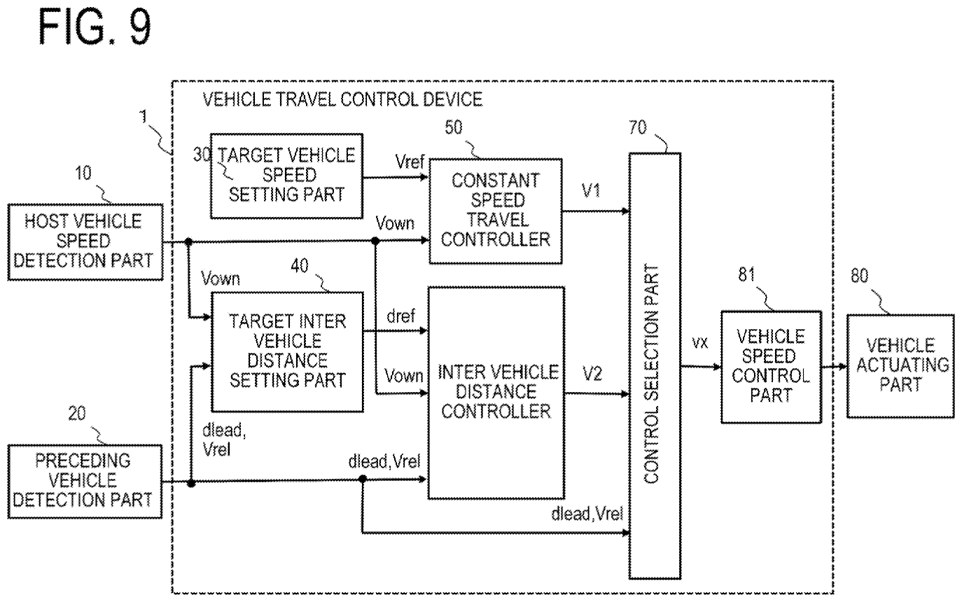

FIG. 9 is a block diagram showing the constitution of the vehicle travel control device 1, which is a modified example of the Embodiment 1. In addition to the block diagram of FIG. 1, FIG. 9 shows a constitution in which a vehicle speed control part 81 is added. In the present constitution shown in FIG. 9, the constant speed travel controller 50 outputs a first vehicle speed instruction v1 for performing the constant speed travel control, and the inter vehicle distance controller 60 outputs a second vehicle speed instruction v2 for controlling to the target inter vehicle distance. And, the control selection part 70 selects either one of the first vehicle speed instruction v1 of the constant speed travel controller 50 and the second vehicle speed instruction v2 of the inter vehicle distance controller 60, and outputs a vehicle speed instruction vx to the vehicle speed control part 81. And, the vehicle speed control part 81 calculates an acceleration instruction for matching the host vehicle speed with the vehicle speed instruction vx, and outputs it to the vehicle actuating part 80. In this way, the vehicle travel control device 1 may be configured to have a vehicle speed control part 81 in the middle.

### Embodiment 2

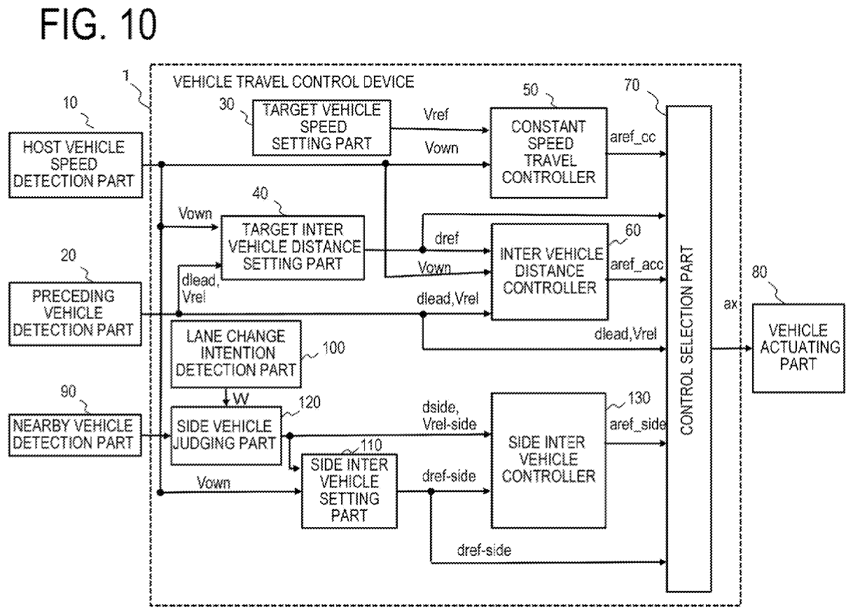

Explanation will be made about the vehicle travel control device 1 according to the Embodiment 2. FIG. 10 is a block diagram showing the constitution of the vehicle travel control device 1 according to the Embodiment 2. In the present Embodiment 2, explained is a case where a side vehicle located in the side is treated as a nearby objective vehicle.

FIG. 10 shows a vehicle travel control device in which a lane change intention detection part 100, a side inter vehicle setting part 110, a side vehicle judging part 120, and a side inter vehicular controller 130 are added in the vehicle travel control device 1 according to the Embodiment 1, which is shown in FIG. 1. The added blocks, which operate in response to the information from the nearby vehicle detection part 90, are explained below.

In FIG. 10, the nearby vehicle detection part 90 is a sensor, for example, a milli wave radar, a camera, a LiDAR, and the like, which detect the information on nearby vehicles which include vehicles on the right and left lanes of the host vehicle lane. The nearby vehicle detection part 90 outputs position information and relative speed information on a plurality of nearby vehicles, to the side vehicle judging part 120.

The lane change intention detection part 100 detects the intention of lane change of a driver. For example, the lane change intention detection part detects driver's intention to change lanes, based on the operation of a blinker, at the time when the driver of a host vehicle notifies the intention to change lanes to other vehicles which exist in the vicinity.

Based on the blinker information W showing the lane change intention of a driver which is output from the lane change intention detection part 100, the side vehicle judging part 120 outputs an inter vehicle distance d_{side} with respect to a side vehicle which is the nearest to the host vehicle and running on the next lane of lane change destination, and a relative speed v_{rel_side} with respect to the side vehicle.

The side inter vehicle setting part 110 outputs an inter vehicle distance d_{ref_f}, which is required when changing lanes to the front side of a side vehicle, and an inter vehicle distance d_{ref_r}, which is required when changing lanes to the rear side of a side vehicle. At the same time, the side inter vehicle setting part judges which to move and change lanes to the front side or the rear side of the side vehicle, and outputs a side target inter vehicle d_{ref_side}, which is a target value of the side inter vehicle controller 130.

The side inter vehicle controller 130 outputs a third acceleration instruction a_{ref_side}, for securing an inter vehicle distance to change lanes, based on the inter vehicle distance d_{side} with respect to a side vehicle, the relative speed v_{rel_side} with respect to a side vehicle, and the side target inter vehicle d_{ref_side}. Here, the constant speed travel controller 50 outputs a value of the first acceleration instruction a_{ref_cc}, and the inter vehicle distance controller 60 outputs a value of the second acceleration instruction a_{ref_acc}.

The control selection part 70 outputs the acceleration instruction ax to the vehicle actuating part 80, based on the value of the first acceleration instruction value a_{ref_cc} which the constant speed travel controller 50 outputs, the value of the second acceleration instruction a_{ref_acc} which the inter vehicle distance controller 60 outputs, the third acceleration instruction a_{ref_side} which the side inter vehicle controller 130 outputs, d_{ref} which is a target value of the inter vehicle distance controller 60, and d_{ref_side} which is a target value of the side inter vehicle controller 130.

Next, explanation will be made in detail about the operation of each part of the vehicle travel control device 1. Based on the blinker information W, the lane change intention detection part 100 outputs any one of “no intention to change lanes” or “change lanes to right lane” or “change lanes to left lane”, to the side vehicle judging part 120.

Based on the lane change intention of a driver, the side vehicle judging part 120 judges the vehicle nearest to the host vehicle as a side vehicle, from among a plurality of side vehicles which are running on the next lane of lane change destination. And, the side vehicle judging part outputs the inter vehicle distance d_{side} with respect to a side vehicle and the relative speed v_{rel_side} side with respect to a side vehicle. When a driver shows no intention to change lanes, the side vehicle judging part indicates that there is no side vehicle.

The side inter vehicle setting part 110 calculates a front side inter vehicle distance d_{ref_f} which is required when a host vehicle changes lanes to the front side of a side vehicle, and a rear side inter vehicle distance d_{ref_r} which is required when a host vehicle change lanes to the rear side of a side vehicle.

### Formula 6

Formula 6

d_{ref_f}=−T_{hw_f}×(v_{own}+v_{rel_side})−d_{stop_f} (6)

### Formula 7

Formula 7

d_{ref_r}=T_{hw_r}×(v_{own}+v_{rel_side})+d_{stop_r} (7)

In the Formula 6 and the Formula 7, symbol T_{hw_f} and symbol T_{hw_r} are coefficients, and symbol d_{stop_f} and symbol d_{stop_r} are offsets, and all of them are positive values. Since a side vehicle is located at the rear side, the front side target inter vehicle distance d_{ref_f} is a negative value. The front side target inter vehicle distance d_{ref_f} and the rear side target inter vehicle distance d_{ref_r} may be equally set up to the target inter vehicle distance d_{ref} with respect to a preceding vehicle, or may be fixed values which are not dependent on speed, by assigning zero to the coefficients T_{hw_f} and T_{hw_r}.

Based on the inter vehicle distance d_{side} with respect to a side vehicle and the relative speed v_{rel_side} with respect to a side vehicle, the side inter vehicle setting part 110 judges which to change lanes between the front side of a side vehicle or the rear side, and outputs a side target inter vehicle d_{ref_side} which is a target value of the side inter vehicle controller 130. For example, when the inter vehicle distance d_{side} with respect to a side vehicle is positive (the side vehicle is at the front side of the host vehicle), it is considered that d_{ref_side}=d_{ref_r}. Further, when the inter vehicle distance d_{side} with respect to a side vehicle is negative (the side vehicle is at the rear side of the host vehicle), it is considered that d_{ref_side}=d_{ref_f}. Or, when the relative speed v_{rel_side} with respect to a side vehicle is positive (the side vehicle is fast), it is considered that d_{ref_side}=d_{ref_r}. Further, when the relative speed v_{rel_side} with respect to a side vehicle is negative (the side vehicle is slow), it is considered that d_{ref_side}=d_{ref_f}.

The side vehicle judging part 12 outputs the inter vehicle distance with respect to a side vehicle, which is the nearest to the host vehicle, where the side vehicle is running on the next lane of lane change destination. Based on the inter vehicle distance d_{side} with respect to the nearest side vehicle, and the relative speed v_{rel_side} with respect to the side vehicle, and the target side inter vehicle distance d_{ref_side} calculated in the side inter vehicle setting part 110, the side inter vehicle controller 130 outputs the third acceleration instruction a_{ref_side} for securing an interval to change lanes, matching the inter vehicle distance d_{side} with the target side inter vehicle distance d_{ref_side}.

Next, explanation will be made about how to select an acceleration instruction in the control selection part 70. When the inter vehicle distance d_{side} with respect to a side vehicle is between the front side target inter vehicle d_{ref_f} and the rear side target inter vehicle d_{ref_r}, the side vehicle is running almost next to the host vehicle, and does not have a space for changing lanes. Therefore, when the Formula 8 shown below is satisfied, the host vehicle needs to switch to the control according to the output of the side inter vehicle controller 130, in order to secure a space for changing lanes.

### Formula 8

Formula 8

d_{ref_f}<d_{side}<d_{ref_r} (8)

Moreover, lane change requires a fixed time. Then, a time required to change lanes is set to be T_{lc}. When both of a host vehicle and a side vehicle run at a fixed speed, the inter vehicle distance with respect to the side vehicle changes to d_{side}+v_{rel_side}×T_{lc}, after the time of T_{lc}. When this inter vehicle distance is between the front side target inter vehicle d_{ref_f} and the rear side target inter vehicle d_{ref_r}, it means that the host vehicle cannot secure an inter vehicle, during the lane change. Therefore, when the following Formula 9 is satisfied, the host vehicle needs to switch the control for securing a space for changing lanes, to the side inter vehicle control.

### Formula 9

Formula 9

d_{ref_f}<d_{side}+v_{rel_side}×T_{lc}<d_{ref_r} (9)

Moreover, based on the conditions in the Embodiment 1, adjusting the acceleration or deceleration, which occurs in the side inter vehicle controller 130, with a setting acceleration A_{side}, is considered. When the Formula 10 shown below is satisfied, the host vehicle needs to switch the control for securing a space for changing lanes, to the side inter vehicle controller.

$$[ Formula 10 ]$$

$$\begin{matrix}Formula 10 & \\ {d}_{ref \_ f} - sign ( {v}_{rel \_ side} ) \times \frac{{v}_{rel \_ side}^{2}}{( 2 \times {A}_{s i d e} )} < {d}_{side} < {d}_{ref \_ r} - sign ( {v}_{rel \_ side} ) \times \frac{{v}_{rel \_ side}^{2}}{( 2 \times {A}_{s i d e} )} & ( 10 )\end{matrix}$$

When the above Formula 8 to Formula 10 are re-arranged, the following Formula 11 and Formula 12 can be obtained.

That is, when the Formula 11 or the Formula 12 is satisfied, the control selection part 70 selects the side inter vehicle controller 130, and sets acceleration instruction ax=a_{ref_side}.

$$[ Formula 11 ]$$

$$\begin{matrix}Formula 11 & \\ \{ \begin{matrix}- \frac{{v}_{rel \_ side}^{2}}{( 2 \times {A}_{s i d e} )} + {d}_{ref \_ f} < {d}_{side} < {d}_{ref , r} & ( {v}_{rel \_ side} \geq 0 ) \\ {d}_{ref \_ f} < {d}_{side} < \frac{{v}_{rel \_ side}^{2}}{( 2 \times {A}_{s i d e} )} + {d}_{ref , r} & ( {v}_{rel \_ side} < 0 )\end{matrix} & ( 11 )\end{matrix}$$

### Formula 12

Formula 12

{−v_{rel_side}×T_{lc}+d_{ref_f}<d_{side}<d_{ref_r}(v_{rel_side}≥0)

d_{ref_f}<d_{side}<−v_{rel_side}×T_{lc}+d_{ref_r}(v_{rel_side}<0) (12)

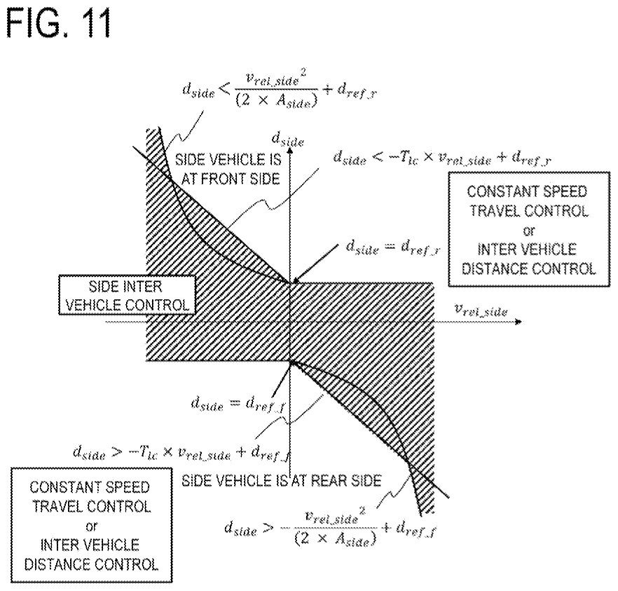

In FIG. 11, shown is a domain in which the control selection part 70 selects the side inter vehicle control which is defined by the Formula 11 and the Formula 12. In FIG. 11, the horizontal axis indicates the side vehicle relative speed v_{rel_side}, and the vertical axis indicates the side vehicle inter vehicle distance. Further, the right hand side (the first quadrant and the fourth quadrant) shows a domain where the host vehicle M0 is slow, and the left hand side (the second quadrant and the third quadrant) shows a domain where the host vehicle M0 is fast, and the upper side shows a domain where the side vehicle M2 is at the front side. In FIG. 11, the hatched domain shows an area where, when the Formula 11 or the Formula 12 is satisfied, the control selection part selects an acceleration instruction a_{ref_side}, which the side inter vehicle controller 130 outputs.

When the Formula 11 and the Formula 12 are not satisfied, the control selection part 70 selects the first acceleration instruction of the constant speed travel controller 50 or the second acceleration instruction of the inter vehicle distance controller 60. As for the selection between the constant speed travel control and the inter vehicle distance control, when the conditions described in the Embodiment 1, that is, the Formula 4 is satisfied, the control selection part selects the second acceleration instruction which the inter vehicle distance controller 60 outputs, and sets a_{ref}=a_{ref_acc}. Further, when the Formula 4 is not satisfied, the control selection part selects the first acceleration instruction which the constant speed travel controller 50 outputs, and sets a_{ref}=a_{ref_cc}.

The constitution of the vehicle travel control device 1 explained above can be constituted using a computer, like the vehicle travel control device 1 described in the Embodiment 1, and each of these constitutions is achieved, when computer runs programs. Namely, the target vehicle speed setting part 30, the target inter vehicle distance setting part 40, the constant speed travel controller 50, the inter vehicle distance controller 60, the control selection part 70, the lane change intention detection part 100, the side vehicle judging part 120, the side inter vehicle setting part 110, and the side inter vehicle controller 130, which are in the vehicle travel control device 1 shown in FIG. 10, are achieved, for example, by the processing circuit 11 shown in FIG. 3. Moreover, hardware configuration in the case where the vehicle travel control device 1 shown FIG. 10 is constituted using processors is the constitution shown in FIG. 4.

### <Operation>

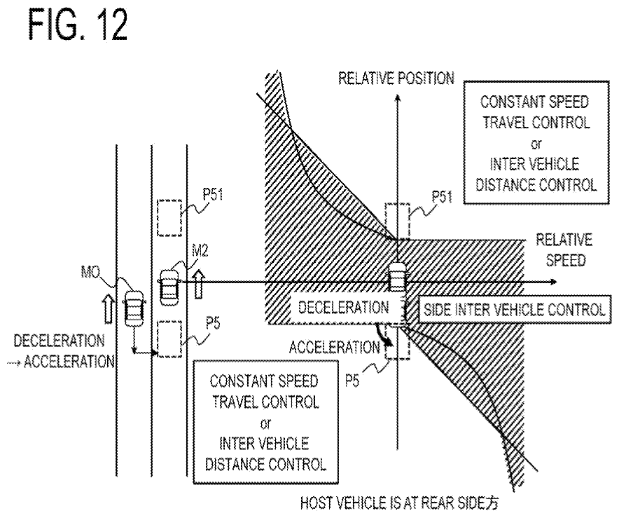

Next, explanation will be made about the operation of the vehicle travel control device 1. FIG. 12 is an explanatory diagram showing the operation of the control selection part 70.

FIG. 12 shows the case where, when the host vehicle M0 changes lanes, another vehicle (side vehicle M2) exists on the adjacent lane of the lane change destination. At this time, the host vehicle M0 is running at s constant speed, that is, at the target vehicle speed desired by a driver.

The drawing on the left hand side of FIG. 12 shows the positional relationship diagram between a side vehicle M2 and a host vehicle M0. And, the drawing on the right hand side of FIG. 12 shows a graph, where the horizontal axis indicates the relative speed vᵣₑₗ of a host vehicle M0 with respect to side vehicle speed, and the vertical axis indicates the relative position of a host vehicle with respect to a preceding vehicle. And, the hatched domain of the right drawing in FIG. 12 shows a domain where the conditions of the Formula 11 and the Formula 12 are fulfilled, and the control selection part switches to the side vehicle inter vehicle distance control. In order to describe the operation example of the present Embodiment, in association with a drawing on the left hand side and a drawing on the right hand side, the right hand side graph of FIG. 12 is shown based on the graph of FIG. 11, where the horizontal axis indicates the relative speed v_{rel_side} of the side vehicle M2 with respect to the host vehicle M0 and the vertical axis indicates the side inter vehicle distance, by inverting both the vertical axis and the horizontal axis.

When the lane change intention of a driver is detected by the lane change intention detection part 100, the side inter vehicle controller 130 secures the inter vehicle distance with respect to the side vehicle which exist on the lane of lane change destination, and thereby, supports the lane change operation of a driver. After moving to the target position P5 and securing the inter vehicle distance, a driver can change lanes by hand safely. Or it is allowed to change lanes automatically, using a lane keeping assistance system (LKA: Lane Keeping Assistance System) which follows a driving lane by controlling steering.

That is, as shown in FIG. 12, on the phase plane where the horizontal axis indicates the host vehicle relative speed vᵣₑₗ, and the vertical axis indicates the host vehicle relative position, switching can be defined among the constant speed travel control, the inter vehicle distance control, and the side inter vehicle control. Further, the boundary line (switching timing of control) between the constant speed travel control and the side inter vehicle control can be shown by the curve line of the above Formula 11 and Formula 12.

On the phase plane shown in FIG. 12, when the host vehicle M0 changes lanes and the above Formula 11 and Formula 12 are satisfied, it is judged that there exists a side vehicle M2 on the adjacent lane of lane change destination, with which the inter vehicle distance should be secured. Therefore, when switched from the constant speed travel control to the side inter vehicle control, the vehicle travel control device decelerates the host vehicle M0, enlarges a host vehicle relative position, increases the inter vehicle with respect to the side vehicle M2, drives the host vehicle M0 to change lanes, and moves to the target position P5 at the rear side of the side vehicle M2. Thereafter, the vehicle travel control device accelerates the host vehicle M0 so that the host vehicle may follow the setting inter vehicle distance calculated in the side inter vehicle setting part 110.

By defining the conditions for switching to the side inter vehicle control, like the Formula 11 and the Formula 12, not only when the side vehicle M2 exists right next to the host vehicle M0 (d_{ref_f}<d_{side}<d_{side_r}), also when the host vehicle is approaching a side vehicle M2 which is at the front side and slower than the host vehicle M0, or when a side vehicle M2 faster than the host vehicle M0 is approaching from the rear side, switching is carried out to the side inter vehicle control and a distance for lane change is secured. Thereby, it becomes possible to support safe lane change.

Furthermore, in the case where the host vehicle is approaching a side vehicle M2 which is at the front side and slower than the host vehicle M0, or in the case where a side vehicle M2 faster than the host vehicle M0 is approaching from the rear side, conditions are defined, using the acceleration a_{side}, by the secondary curve of the Formula 11. Thereby, an acceleration instruction a_{acc_side} of the side vehicle inter vehicle distance control can be set up. That is, when it is judged that an acceleration instruction exceeds a predetermined value, the control selection part select the third acceleration instruction of the side inter vehicle controller 130, where the acceleration instruction is calculated in order to control the inter vehicle distance, based on the inter vehicle distance between a host vehicle and a side vehicle, the relative speed, and the target side inter vehicle distance.

In the case where the host vehicle M0 changes lanes, on the phase plane shown in FIG. 12, it can be judged that the lane change space is already secured, when the Formula 11 and the Formula 12 are not satisfied, or it can be judged that the space for changing lanes is secured, just by continuing the drive by the constant speed travel control due to a large speed difference. Therefore, the control selection part 70 selects the first acceleration instruction a_{cc1}, which is the output by the constant speed travel controller 50. Accordingly, in the case where the host vehicle M0 changes lanes, when the lane change space is already secured, or when the space for changing lanes is secured, just by continuing the driving by the constant speed travel control due to a large speed difference, an unnecessary deceleration can be restrained, by not switching to the side inter vehicle control, and the host vehicle M0 can be smoothly moved to the target position P51, without giving a sense of discomfort to a driver.

Moreover, as a modified example of the Embodiment 2, like the modified example of the Embodiment 1, the vehicle travel control device may have the constitution in which the vehicle speed control part 81 is added between the control selection part 70 and the vehicle actuating part 80. In such a case, the constant speed travel controller 50, the inter vehicle distance controller 60, and the side inter vehicle controller 130 outputs a vehicle speed instruction each. And, from among the first vehicle speed instruction which the constant speed travel controller 50 outputs, the second vehicle speed instruction which the inter vehicle distance controller 60 outputs, and the third vehicle speed instruction which the side inter vehicle controller 130 outputs, the control selection part 70 selects one instruction, and outputs it to the vehicle speed control part 81. And, the vehicle speed control part 81 calculates an acceleration instruction for matching the host vehicle speed with the vehicle speed instruction, and outputs it to the vehicle actuating part 80.

### Embodiment 3

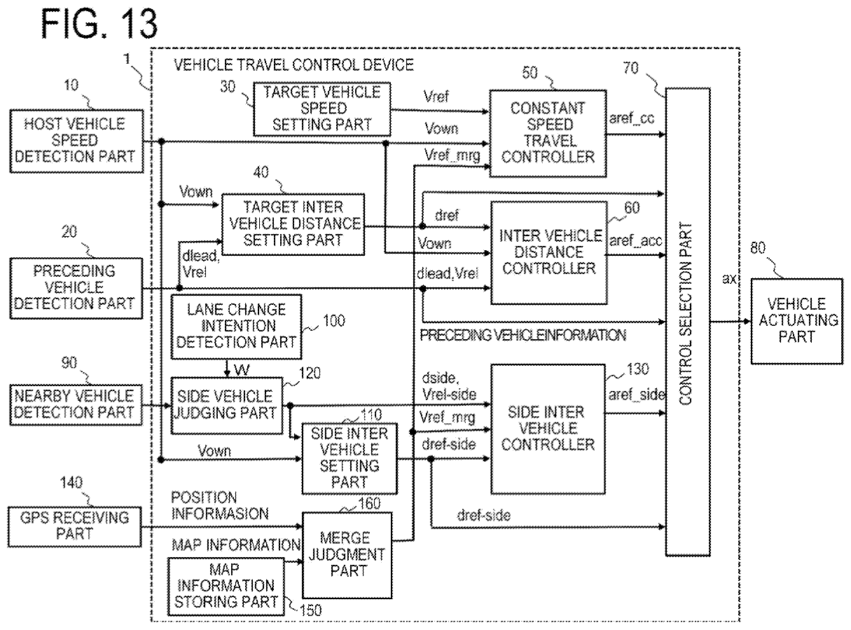

Explanation will be made about the vehicle travel control device 1 according to the Embodiment 3. FIG. 13 is a block diagram showing the constitution of the vehicle travel control device 1 of the Embodiment 3. In FIG. 13, a GPS receiving part 140, a map information storing part 150, and a merge judgment part 160 are added to the vehicle travel control device 1 of the Embodiment 2. The added blocks are explained below.

The GPS receiving part 140 receives electric waves from GPS Satellites, and outputs the information for computing the current position of a host vehicle, and the vehicle travel control device 1 acquires this signal, and acquires the current position of a host vehicle.

The map information storing part 150 corresponds to, for example, a navigation system which is mounted in the host vehicle, and map information is stored there.

Based on the map information from the map information storing part 150, and the position information on the host vehicle from the GPS receiving part 140, the merge judgment part 160 judges whether lanes can be changed, in the merge section of a high-speed way, with the present speed of the host vehicle. When it is judged that the remaining distance of the merge section is insufficient as the distance required to change lanes, a vehicle speed instruction v_{ref_mrg} for changing lanes in the remaining distance of the merge section is output to the constant speed travel controller 50 or the side inter vehicle controller 130. That is, the merge judgment part calculates and outputs a vehicle speed required to complete lane change within a predetermined distance.

Next, explanation will be made in detail about the operation of each part of the control selection part 70. Based on the map information from the map information storing part 150, and the position information from the GPS receiving part 140, the merge judgment part 160 calculates a merge distance x_{mrg}, which is the remaining distance from the host vehicle position in the merge section of a high-speed way to the termination of the merge section. When a host vehicle is running at the host vehicle speed v_{own} and changes lanes in time T_{lc}, the distance required to change lanes is denoted by v_{own}×T_{lc}. When the following Formula 13 is satisfied, the host vehicle cannot change lanes at the present host vehicle speed v_{own}, within the merge section, and it is judged that normal merging is impossible.

### Formula 13

Formula 13

v_{own}×T_{lc}>x_{mrg} (13)

In the situation where the Formula 11 and Formula 12 in the Embodiment 2 are not satisfied and the constant speed travel control is selected, a speed for changing lanes within the merge section will be explained. When the host vehicle runs, decelerating at a fixed deceleration a_{mrg}, and advances from the current position to the merge distance x_{mrg}, after the time of T_{lc}, the following Formula 14 is satisfied.

$$[ Formula 14 ]$$

$$\begin{matrix}Formula 14 & \\ {x}_{mrg} = {v}_{own} \times {T}_{lc} - \frac{1}{2} {a}_{mrg} {T}_{lc}^{2} & ( 14 )\end{matrix}$$

When the Formula 14 is re-arranged, the deceleration a_{mrg} is denoted by the following Formula 15.

$$[ Formula 15 ]$$

$$\begin{matrix}Formula 15 & \\ {a}_{mrg} = \frac{2 ( {v}_{own} \times {T}_{lc} - {x}_{mrg} )}{{T}_{lc}^{2}} & ( 15 )\end{matrix}$$

From the above, the host vehicle controls the vehicle speed to performs lane change, according to the vehicle speed instruction v_{ref_mrg}, which instructs the deceleration at a deceleration a mrg denoted by the Formula 15. Thereby, in the constant speed travel control, lane change can be performed within the merge distance x_{mrg}.

Next, explanation will be made about the speed for changing lanes within a merge section, in the situation where the Formula 11 or the Formula 12, that is, conditions in the Embodiment 2, is satisfied and the side inter vehicle control is selected. In contrast with step inputs from an inter vehicle distance d_{side} with respect to a present side vehicle to a target value d_{ref_side}, time history d_{ref_mrg} of the inter vehicle distance, until a target value is converged, is defined using a filter F(s).

In the following Formula 16, symbol d_{side} is set up as an initial value of the inter vehicle distance, and symbol v_{rel_side} is set up as an initial value of the relative speed vᵣₑₗ.

### Formula 16

Formula 16

d_{ref_mrg}=F(s)d_{ref_side} (16)

At this time, the time history v_{ref_mrg} of a host vehicle speed is defined using the differential value of d_{ref_mrg}, like the following formula.

$$[ Formula 17 ]$$

$$\begin{matrix}Formula 17 & \\ {v}_{ref \_ mrg} = ( {v}_{own} + {v}_{rel \_ side} ) - \frac{d}{dt} ( {d}_{ref \_ mrg} ) & ( 17 )\end{matrix}$$

The filter F(s) is defined like the Formula 18. The Formula 18 is a two-step moving average filter, in which two moving average filters are combined.

$$[ Formula 18 ]$$

$$\begin{matrix}Formula 18 & \\ F ( s ) = ( \frac{1}{{τ}_{d}} \frac{1 - exp ( - {τ}_{d} s )}{s} ) ( \frac{1}{{τ}_{d}} \frac{1 - exp ( - {τ}_{d} s )}{s} ) & ( 18 )\end{matrix}$$

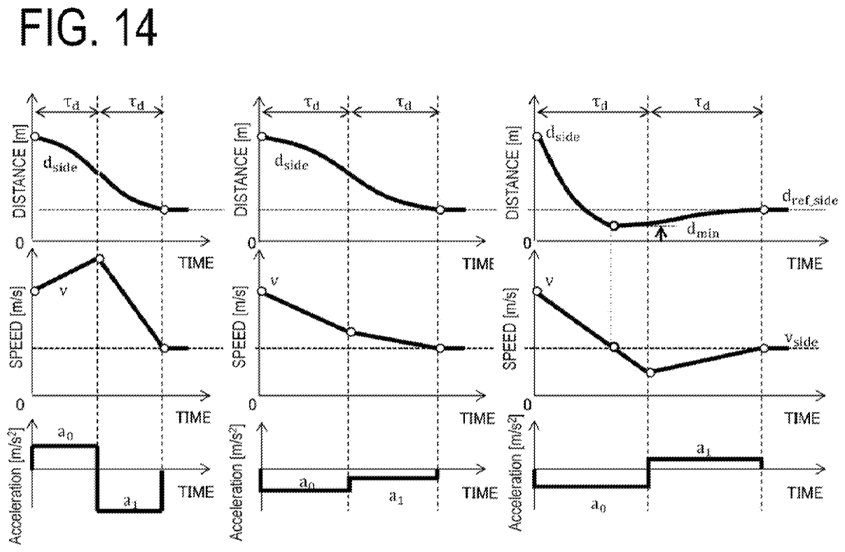

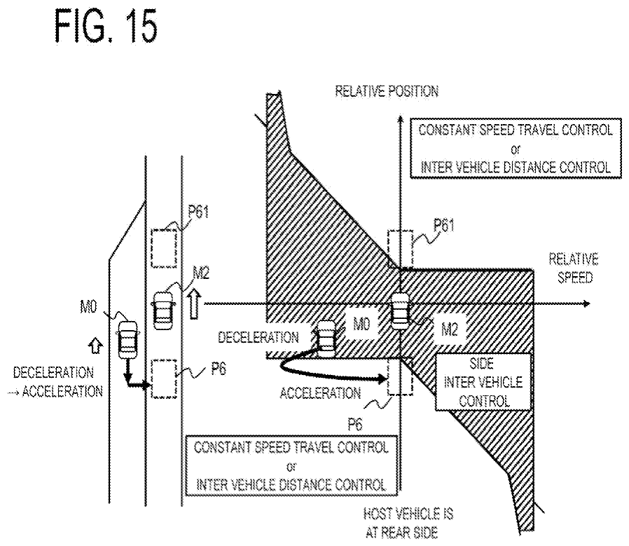

The operation examples of d_{ref_mrg} and v_{ref_mrg}, which are outputs of a moving average filter, are shown in FIG. 14. The left hand side portion is a case example when filter processes are treated with a small value of time constant τ_{d}; the central portion is a case example when filter processes are treated with a middle value of time constant τ_{d}; and the right hand side portion is a case example when filter processes are treated with a large value of time constant τ_{d}. Moreover, the drawings on the top columns show the relationship between distance and time; the drawings on the middle columns show the relationship between speed and time; the drawings on the lower columns show the relationship between acceleration and time. And, the time history of distance and speed, until distance and speed waveform are converged to a target value is shown. When d_{side}<d_{ref_side} (a side vehicle M2 is at the rear side of a host vehicle M0), and in addition, v_{rel_side}>0 (the side vehicle is slower), distance and speed waveform converge on a desired value d_{ref_side}, according to the magnitude of the time constant τ_{d}, in different operation modes, such as, from deceleration to acceleration, from acceleration to acceleration, and from acceleration to deceleration. At this time, the time until the target value is converged is 2×τ_{d}.

A case is considered in which, at the present time, the side vehicle M2 is of the inter vehicle distance d_{side} and at the relative speed v_{rel_side}; after the time of t_{mrg}, the inter vehicle distance is d_{ref_side}, which is a target value, and the relative speed vᵣₑₗ is zero, and the side inter vehicle control is completed; and in the meantime, the host vehicle M0 runs the merge distance x_{mrg}.

At this time, the side vehicle M2 runs as long as x_{mrg}+d_{ref_side}−d_{side}, during the time of t_{mrg}. Therefore, the side inter vehicle control needs to converge to a target value during the time of t_{mrg}, which is denoted by the following Formula 19.

$$[ Formula 19 ]$$

$$\begin{matrix}Formula 19 & \\ {t}_{mrg} = \frac{{x}_{mrg} + {d}_{ref \_ side} - {d}_{s i d e}}{{v}_{o w n} + {v}_{rel \_ side}} & ( 19 )\end{matrix}$$

From the reason mentioned above, the time constant τ_{d} of a moving average filter is determined as follows.

$$[ Formula 20 ]$$

$$\begin{matrix}Formula 20 & \\ {T}_{d} = \frac{1}{2} {t}_{mrg} = \frac{{x}_{mrg} + {d}_{ref \_ side} - {d}_{s i d e}}{2 ( {v}_{own} + {v}_{rel \_ side} )} & ( 20 )\end{matrix}$$

Time history d_{ref_mrg} of the inter vehicle distance is calculated using the time constant τ_{d} of the Formula 20 and the filter F (S). Under the situation where the merge section is short and a quick lane change is necessary, and in the situation where a fast side vehicle is approaching from the rear side, the time history d_{ref_mrg} of the inter vehicle distance is that the host vehicle takes an operation for strong deceleration, as shown in the drawing on the left side of FIG. 14 (an example with the smallest τ_{d}).

The control selection part 70 selects one output, from among the first acceleration instruction a_{ref_cc} which the constant speed travel controller 50 outputs, a value of the second acceleration instruction a_{ref_acc} which the inter vehicle distance controller 60 outputs, and the third acceleration instruction a_{ref_side} which the side inter vehicle controller 130 outputs, where those acceleration instructions are output on the same conditions as the Embodiment 2. Further, the control selection part outputs the selected acceleration instruction to the vehicle actuating part 80.

The configuration of the vehicle travel control device 1 explained above can be constituted using a computer, like the vehicle travel control device 1 whose description is given in the Embodiment 1, and the vehicle travel control device 1 whose description is given in the Embodiment 2. Each of these constitutions is achieved when programs are executed on the computer. That is, the target vehicle speed setting part 30, the target inter vehicle distance setting part 40, the constant speed travel controller 50, the inter vehicle distance controller 60, the control selection part 70, the vehicle actuating part 80, the nearby vehicle detection part 90, the lane change intention detection part 100, the side inter vehicle setting part 110, the side vehicle judging part 120, the side inter vehicle controller 130, the GPS receiving part 140, the map information storing part 150, and the merge judgment part 160, which are in the vehicle travel control device 1 shown in FIG. 13, are achieved, for example, by the processing circuit 11, shown in FIG. 3. Moreover, hardware configuration in the case where the vehicle travel control device 1 shown FIG. 13 is constituted using processors is the constitution shown in FIG. 4.

### <Operation>

Hereinafter, explanation will be made about the operation of the vehicle travel control device 1. FIG. 15 is an explanatory diagram for explaining the operation of the control selection part 70.

FIG. 15 shows the case where, when the host vehicle M0 changes lanes in a merge section, there exists another vehicle (a nearby vehicle) which is located on an adjacent lane of lane change destination. At this time, the host vehicle M0 is running at a constant speed, that is, at the target vehicle speed desired by a driver. When the lane on which the host vehicle M0 is running does not belong to a merge section, the vehicle travel control device accelerates, performing the same control as the Embodiment 2, and moves the host vehicle M0 to the target position P61 smoothly.

In a merge section, the host vehicle M0 is in the state of constant speed travel. When the host vehicle changes lanes into the adjacent lane on which the side vehicle is running, the vehicle travel control device switches from the constant speed travel control to the side inter vehicle control, and decelerates. Further, the side inter vehicle control may control the host vehicle M0, and after that, the vehicle travel control device accelerates, in order to maintain a target interval, and moves the host vehicle smoothly to the target position P6, shown in FIG. 15.

That is, as shown in FIG. 15, on the phase plane where the horizontal axis indicates the host vehicle relative speed vᵣₑₗ, and the vertical axis indicates the host vehicle relative position, switching can be defined, among the constant speed travel control, the inter vehicle distance control, and the side inter vehicle control. Further, the boundary line (switching timing of control) between the constant speed travel control and the side inter vehicle control can be shown by the curve lines of the Formula 11 and the Formula 12.

On the phase plane shown in FIG. 15, when the host vehicle M0 changes lanes, and in addition, the Formula 11 or the Formula 12 (Formulas of the Embodiment 2) is satisfied, it is judged that, like the case of the Embodiment 2, there exists a side vehicle M2 on the adjacent lane of lane change destination, and the vehicle travel control device switches to the side inter vehicle control. At this time, when it is judged that, the Formula 17 is satisfied, and the merge distance x_{mrg} is insufficient, and normal merging is impossible, the vehicle travel control device carries out the side inter vehicle control to match with d_{ref} mrg and v_{ref_mrg}, which are the outputs of a two-step moving average filter. Accordingly, strong deceleration is generated to secure the inter vehicle distance within the merge distance x_{mrg}, and lane change can be completed.

Moreover, even when the side vehicle M2 does not exist, if it is judged that the Formula 17 is satisfied and normal merging is impossible, low speed travel control is carried out, according to the vehicle speed instruction v_{ref_mrg} of strong deceleration which follows the Formula 18. Thereby, even when a merge section is short, it is possible to change lanes within the merge section without fail.

Moreover, as another modified example of the vehicle travel control device 1, like the modified example of the vehicle travel control device 1, the vehicle travel control device may have constitution where the vehicle speed control part 81 is added between the control selection part 70 and the vehicle actuating part 80. In such a case, the constant speed travel controller 50, the inter vehicle distance controller 60, and the side inter vehicle controller 130 output a vehicle speed instruction each. And, the control selection part 70 selects any one from among the vehicle speed instructions which the constant speed travel controller 50, the inter vehicle distance controller 60, and the side inter vehicle controller 130 output, and further, outputs the selected instruction to the vehicle speed control part 81. And, the vehicle speed control part 81 calculates an acceleration instruction for matching the host vehicle speed with the vehicle speed instruction, and outputs the calculated instruction to the vehicle actuating part 80.

Although the present application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present application. For example, at least one of the constituent components may be modified, added, or eliminated. At least one of the constituent components mentioned in at least one of the preferred embodiments may be selected and combined with the constituent components mentioned in another preferred embodiment.

### EXPLANATION OF NUMERALS AND SYMBOLS

1 Vehicle travel control device: 11 Processing circuit: 12 Processor: 13 Memory: 10 Host vehicle speed detection part: 20 Preceding vehicle detection part: 30 Target vehicle speed setting part: 40 Target inter vehicle distance setting part: 50 Constant speed travel controller: 60 Inter vehicle distance controller: 70 Control selection part: 80 Vehicle actuating part: 81 Vehicle speed control part: 90 Nearby vehicle detection part: 100 Lane change intention detection part: 110 Side inter vehicle setting part: 120 Side vehicle judging part: 130 Side inter vehicle controller: 140 GPS Receiving part: 150 Map information storing part: 160 Merge judgment part

1. A vehicle travel control device, comprising:
a target vehicle speed setter which outputs a set up target vehicle speed,
a constant speed travel controller which outputs a first acceleration instruction for constant speed travel, from a speed of a host vehicle and the target vehicle speed,
a target inter vehicle distance setter which outputs a target inter vehicle distance between a preceding vehicle and the host vehicle,
an inter vehicle distance controller which outputs a second acceleration instruction for controlling to the target inter vehicle distance, based on a relative speed and an inter vehicle distance between the preceding vehicle and the host vehicle, and
a control selector which receives the first acceleration instruction from the constant speed travel controller and the second acceleration instruction from the inter vehicle distance controller, and selects one of the instructions to make an acceleration instruction,
wherein, the control selector has a predetermined switching acceleration, and selects the second acceleration instruction of the inter vehicle distance controller, when it is judged that the second acceleration instruction may exceed the switching acceleration.

2. The vehicle travel control device given in claim 1,
wherein, in the control selector, as the speed of the preceding vehicle is smaller, the switching acceleration is set to be larger.

3. The vehicle travel control device given in claim 1,
wherein, in the control selector, when the relative speed of the preceding vehicle is positive, the switching acceleration is made smaller than that of a case when the relative speed is negative.

4. The vehicle travel control device given in claim 1,
wherein the inter vehicle distance is denoted by d, the relative speed is denoted by vᵣₑₗ, the target inter vehicle distance is denoted by d_{ref}, and a predetermined acceleration prohibited acceleration is denoted by A_{cc}, and
when a formula of following conditions is satisfied,
the constant speed travel controller prohibits acceleration and controls to maintain the speed of the host vehicle.
$$[ Formula 21 ]$$
$$\begin{matrix}Formula 21 & \\ d < - sign ( {v}_{rel} ) \times \frac{{v}_{rel}^{2}}{( 2 \times {A}_{c c} )} + {d}_{ref} & \end{matrix}$$

5. A vehicle travel control device, comprising:
a target vehicle speed setter which outputs a set up target vehicle speed,
a constant speed travel controller which outputs a first acceleration instruction for constant speed travel from a speed of a host vehicle and the target vehicle speed,
a side inter vehicle setter which outputs a target side inter vehicle distance between a side vehicle and the host vehicle,
a side inter vehicle controller which outputs a third acceleration instruction for controlling to the target side inter vehicle distance, based on a relative speed and an inter vehicle distance between the side vehicle and the host vehicle, and
a control selector which receives a first acceleration instruction from the constant speed travel controller and a third acceleration instruction from the side inter vehicle controller, and selects one of the first acceleration instruction and the third acceleration instruction, to make an acceleration instruction.

6. The vehicle travel control device given in claim 5,
wherein, when the inter vehicle distance between the host vehicle and the side vehicle is a distance insufficient to change lanes, or
when the inter vehicle distance after a time required to change lanes is a distance insufficient to change lanes, or
when it is judged that an acceleration instruction exceeds a predetermined value, where the acceleration instruction is calculated for controlling the inter vehicle distance, based on the inter vehicle distance, the relative speed, and the target side inter vehicle distance,
the control selector selects the third acceleration instruction of the side inter vehicle controller.

7. A vehicle travel control device, comprising:
a target vehicle speed setter which outputs a set up target vehicle speed,
a merge judge which calculates and outputs a vehicle speed required to complete lane change within a predetermined distance in which driving lanes are merged,
a side inter vehicle setter which outputs a target side inter vehicle distance between a side vehicle and a host vehicle,
a constant speed travel controller which outputs a first acceleration instruction for constant speed travel, from a speed of a host vehicle, the target vehicle speed of the target vehicle speed setter, and the required vehicle speed of the merge judge,
a side inter vehicle controller which outputs a third acceleration instruction for controlling to the target side inter vehicle distance, based on a relative speed between the side vehicle and the host vehicle, the target side inter vehicle distance of the side inter vehicle setter, and the required speed of the merge judge, and
a control selector which receives the first acceleration instruction from the constant speed travel controller and the third acceleration instruction from the side inter vehicle controller, and selects one of the first acceleration instruction and the third acceleration instruction, to make an acceleration instruction,
wherein lane change is carried out within a predetermined distance.

8. The vehicle travel control device given in claim 7,
wherein, when it is judged that lane change is impossible within a predetermined distance,
the merge judge calculates a deceleration vehicle speed in order to enable lane change, and outputs to the constant speed travel controller, and
the constant speed travel controller calculates an acceleration instruction for matching the speed of the host vehicle with the deceleration vehicle speed.

9. The vehicle travel control device given in claim 7,
wherein, in the merge judge, when it is judged that lane change is impossible within the predetermined distance, at a present speed of the host vehicle,
the merge judge calculates a speed for securing an inter vehicle distance with the side vehicle, within the predetermined distance, and outputs to the side inter vehicle controller, and
the side inter vehicle controller calculates an acceleration instruction for matching the speed of the host vehicle with the speed for securing the inter vehicle distance.

10. The vehicle travel control device given in claim 7,
wherein, when the inter vehicle distance with respect to the side vehicle is a distance insufficient for lane change, or
when the inter vehicle distance with respect to the side vehicle, after a time required for lane change is a distance insufficient for lane change, or
when it is judged that an acceleration instruction exceeds a predetermined value, where the acceleration instruction is calculated in order to control the inter vehicle distance, based on the inter vehicle distance, the relative speed, and the target side inter vehicle distance, with respect to the side vehicle,
the control selector selects the third acceleration instruction of the side inter vehicle controller.
